(19) United States
(12) Patent Application Publication
(10) Pub. No.: US 2017/0288418 A1
(43) Pub. Date: Oct. 5, 2017

(54) Battery Charging System

(71) Applicant: Samuel M. Alexander, Northfield, VT (US)

(72) Inventor: Samuel M. Alexander, Northfield, VT (US)

(21) Appl. No.: 15/475,447

(22) Filed: Mar. 31, 2017

Related U.S. Application Data
(60) Provisional application No. 62/316,014, filed on Mar. 31, 2016.

(51) Int. Cl. H02J 7/00; H01R 31/06

(52) U.S. Cl. CPC H02J 7/007; H02J 7/0045; H02J 7/0021; H01R 31/065

(57) ABSTRACT

A method of controlling the charging of a battery of an electronic device comprises selectively charging the battery according to a first charging mode or a second charging mode. In the first charging mode, the battery is charged uniformly. In the second charging mode, the battery is charged using at least a first charge phase and a second charge phase. A start time of the first charge phase and an end time of the second charge phase are determined according to a specified idle time of the electronic device, the end time of the first charge phase is determined according to a first specified battery charge level, and the start time of the second charge phase is determined according to a difference between the first specified battery charge level and a second specified battery charge level.

### CLAIM OF PRIORITY

This application claims the benefit of priority under 35 U.S.C. §119(e) of U.S. Provisional Patent Application Ser. No. 62/316,014, filed on Mar. 31, 2016, which is herein incorporated by reference in its entirety.

### TECHNICAL FIELD

The present disclosure relates generally to battery-operated devices and specifically to charging the battery of such devices.

### BACKGROUND

Mobile devices, such as mobile phones, smart phones, and tablet computers, have become nearly ubiquitous. These devices usually operate by consuming energy from a rechargeable battery.

Many mobile device users choose to recharge the batteries of their mobile devices during a period when the users are unlikely to use the mobile device. For example, many mobile device users plug in their mobile devices for charging prior to going to sleep; upon waking after a typical night's sleep, the batteries of their mobile devices are fully charged. However, the rechargeable batteries of most mobile devices require substantially less time to fully charge than a typical person sleeps. Leaving a fully charged battery plugged in can lead to the battery overcharging and/or overheating.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments or examples discussed in the present document.

FIG. 1 illustrates an internal perspective view of the cylinder and the screw components of a Smart Charging Adapter, according to an embodiment.

FIG. 2A illustrates the Smart Charging Adapter being used with a standard charging adapter for charging a mobile device, according to an embodiment.

FIG. 2B is a perspective view of the Smart Charging Adapter, according to an embodiment.

FIG. 2C is a partial cut-away perspective view of the Smart Charging Adapter, according to an embodiment.

FIG. 2D is a partial cut-away perspective view of the Smart Charging Adapter, according to an embodiment.

FIG. 2E is a partial cut-away perspective view of the Smart Charging Adapter, according to an embodiment.

FIG. 2F is a partial cut-away perspective view of the Smart Charging Adapter, according to an embodiment.

FIG. 2G is a partial cut-away perspective view of the Smart Charging Adapter, according to an embodiment.

FIG. 2H is a partial cut-away perspective view of the Smart Charging Adapter, according to an embodiment.

FIG. 3 illustrates a charge settings screen of a Smart Charging app UI executing on the mobile device, according to an embodiment.

FIG. 4 illustrates a user interface element of the Smart Charging app UI that allows the user to switch between screens of the Smart Charging app UI, according to an embodiment.

FIG. 5 illustrates a schedule screen of the Smart Charging app UI executing on the mobile device, according to an embodiment.

FIG. 6 illustrates setting waking times using the schedule screen of the Smart Charging app UI, according to an embodiment.

FIG. 7 is a flowchart of the Smart Charging Adapter operating with the Smart Charging app executing on the mobile device, according to an embodiment.

FIG. 8 is a block diagram of the internal circuitry of the Smart Charging Adapter, according to an embodiment.

FIG. 9 is an electrical diagram of an output current controller of the Smart Charging Adapter, according to an embodiment.

FIG. 10 is an electrical diagram of a motor controller of the Smart Charging Adapter, according to an embodiment.

FIG. 11 is an electrical diagram of a power regulator of the Smart Charging Adapter, according to an embodiment.

FIGS. 12A and 12B are an electrical diagram of a processor of the Smart Charging Adapter, according to an embodiment.

### DETAILED DESCRIPTION

The present disclosure describes methods, devices, and computer program products that individually facilitate the charging of mobile device batteries. In the following detailed description, for purposes of explanation, numerous specific details are set forth in order to provide a thorough understanding of the various aspects of the presently disclosed subject matter. However, it will be evident to those skilled in the art, after reading and understanding the present subject matter, that the presently disclosed subject matter may be practiced without these specific details. In other instances, well-known methods, procedures, and components have not been described in detail so as not to obscure the presently disclosed subject matter.

A mobile device charging system includes an application (or “app”) executing on a mobile device and an adapter positioned between a charging connector and a charging port of the mobile device. The app optimizes battery charging using various algorithms. The adapter is able to disconnect itself physically from the charging port of the mobile device, for example when the adapter detects or is informed that the battery of the mobile device is fully charged.

The app has two primary components: a front-facing user interface and a background service controlling the charging component via an interface between the mobile device and the charging component (e.g., universal serial bus (USB) interface). The app's user interface allows a user to set the user's typical waking times, which the background service uses in its calculations. Additionally, the user interface allows the user to choose a charging setting and to see the current state of the battery.

The app may be used alone or in conjunction with the charging component. If used in conjunction with the charging component, the app communicates with the charging component via an appropriate interface, such as USB. Upon connecting to a mobile device, the charging component hardware triggers the app installed on the mobile device to activate. The charging component expects messages that define the desired charging mode and the appropriate charging rate for the desired charging mode in order to charge the phone sufficiently by the waking time set in the UI. The app monitors the battery's charge state; when the app detects that charging should stop, the app sends a cease charging command to the charging component; the cease charging command indicates whether the charging component should simply pause charging or fully disconnect from the mobile device (depending on the chosen charging mode).

The app communicates with the charging component via a cable, which enables the charging component to act as a Host. Using an application program interface (API) of the mobile device (e.g., Android's Open Accessory APIs), the charging component establishes a connection with the mobile device, thus triggering the app to open. If the app is not installed on the mobile device, the charging component provides the mobile device with an address, hyperlink or universal resource locator (URL) of a site providing a download of the app, and instructs the mobile device to open a web browser to the URL. After performing the calculations, the app sends messages to the Host (charging component) in an appropriate format to communicate the following information:

A signal to trigger charging, including the appropriate charging rate (e.g., number of milliampere-hours (mAh)).

A signal to stop charging

A signal to indicate whether the charging component should physically disconnect from the mobile device. In an embodiment, the disconnect signal will normally indicate not to disconnect. When the battery reaches 100% capacity, the disconnect signal will reflect the user's settings within the app.

The app expects from the charging component messages communicating the following information in an appropriate format to communicate the following information: a signal to launch the app, including a URL of a site providing a download of the app (if the app is not already installed).

The app includes a background process that tracks the battery's charge and communicates commands to the charging component either to start or stop charging. This background process also periodically updates the battery charge indicator in the app UI.

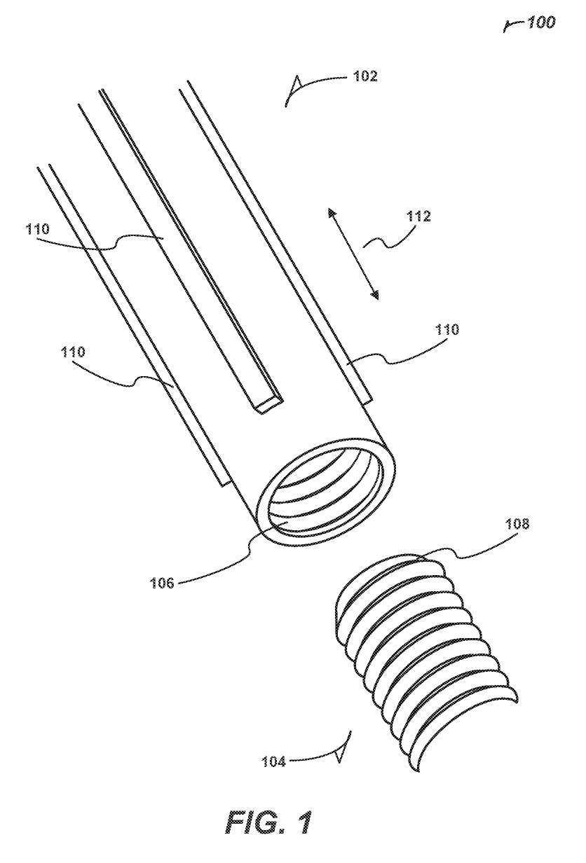

FIG. 1 illustrates an internal perspective view 100 of the cylinder 102 and the screw 104 components of a Smart Charging Adapter, according to an embodiment. The cylinder 102 and the screw 104 are both internal to the charging adapter. One end of the cylinder 102 has a threaded interior 106, allowing the screw 104 to be threaded into and out of the cylinder 102. The cylinder 102 also has one or more rails 110, which prevents the cylinder 102 from rotating yet allow the cylinder 102 to move along the axis 112 that is parallel to the rails 110.

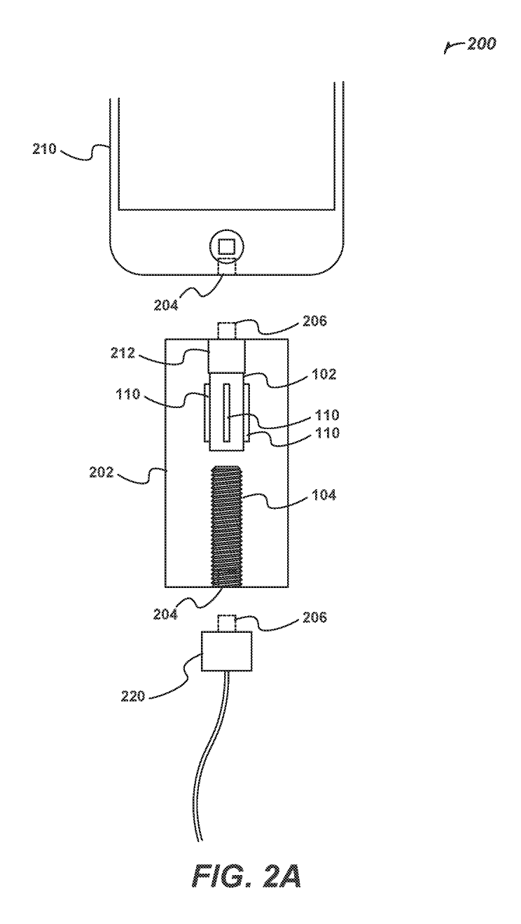

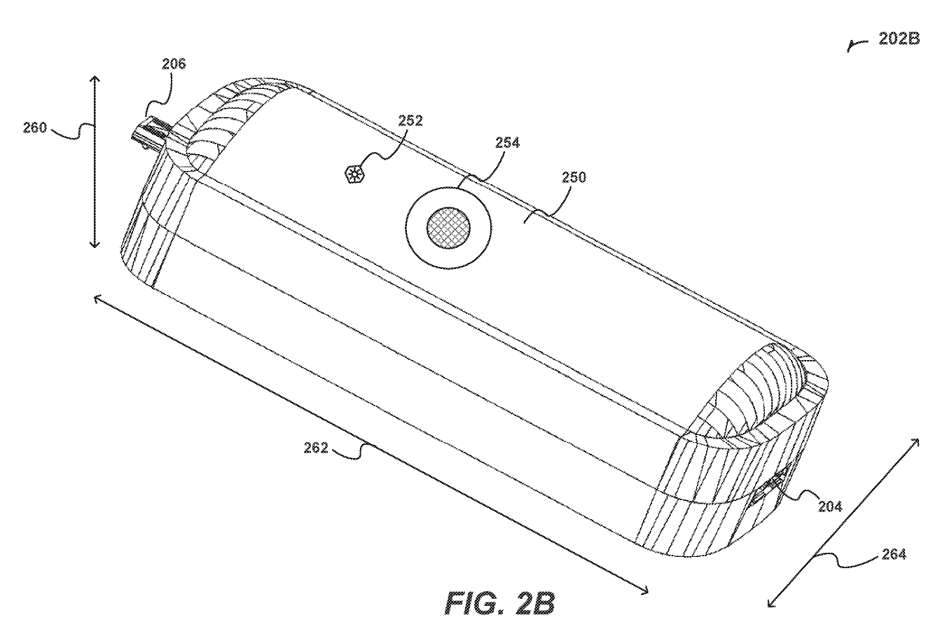

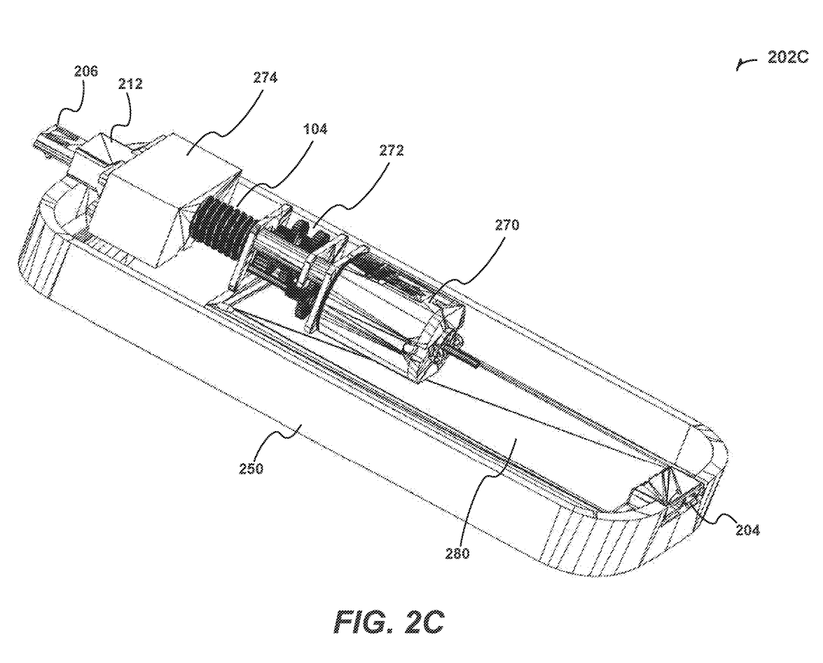

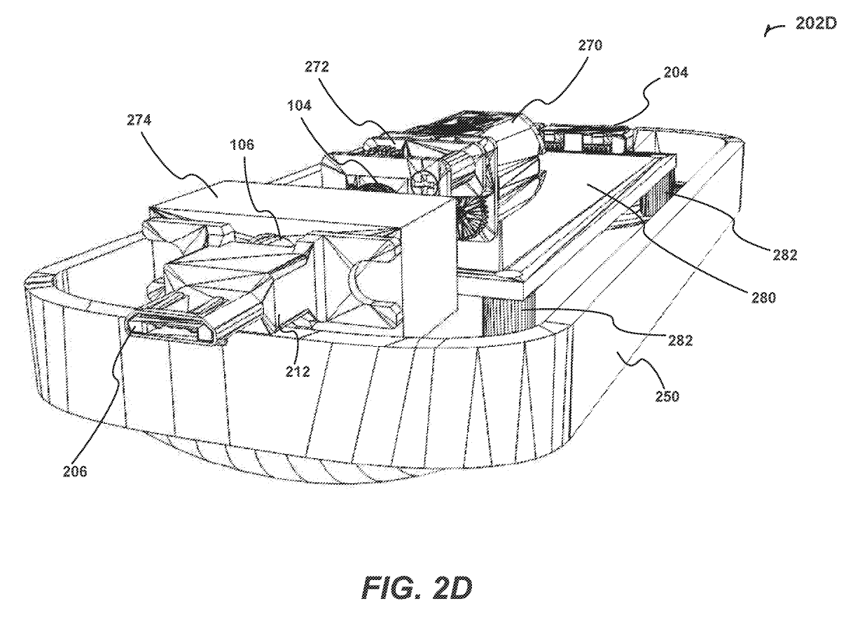

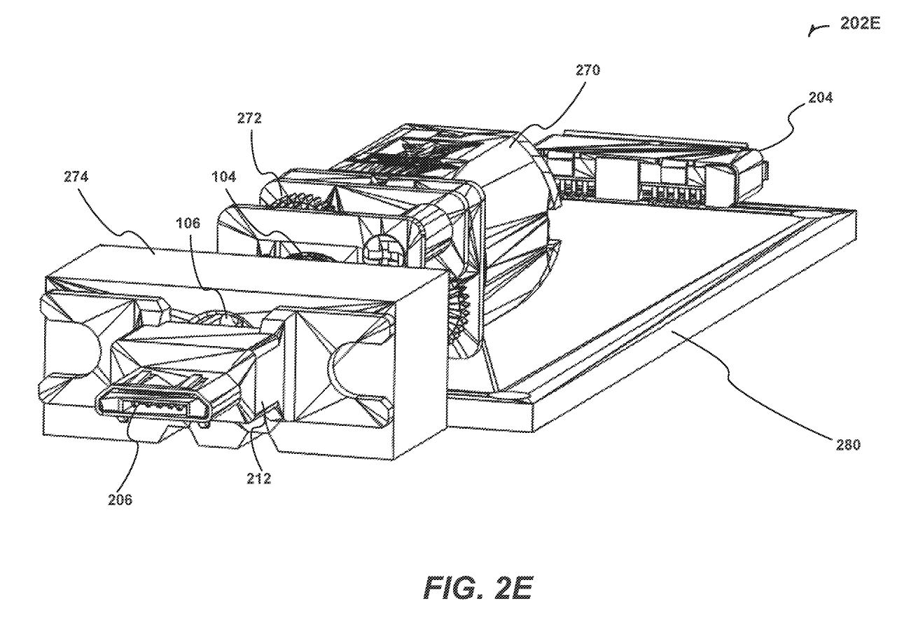

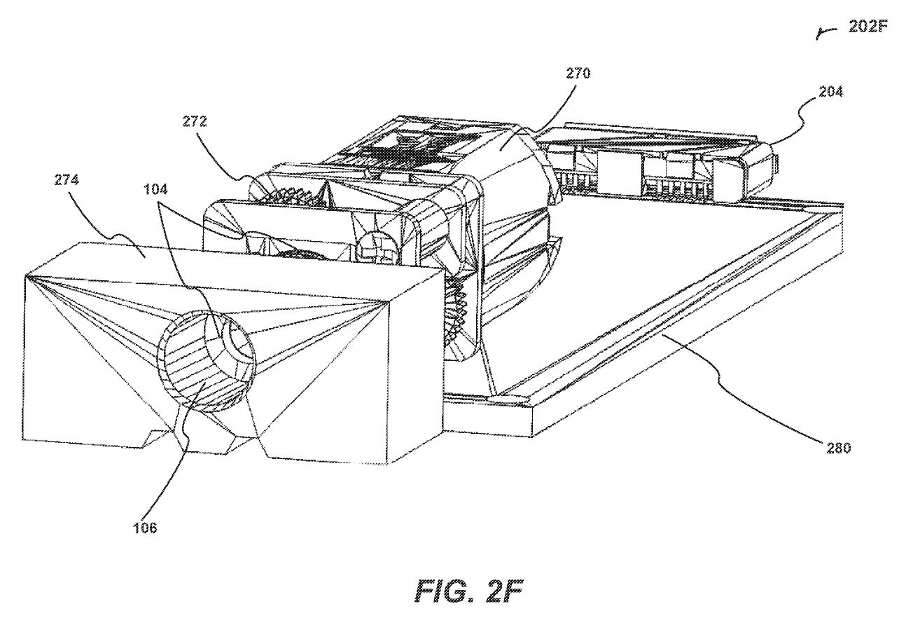

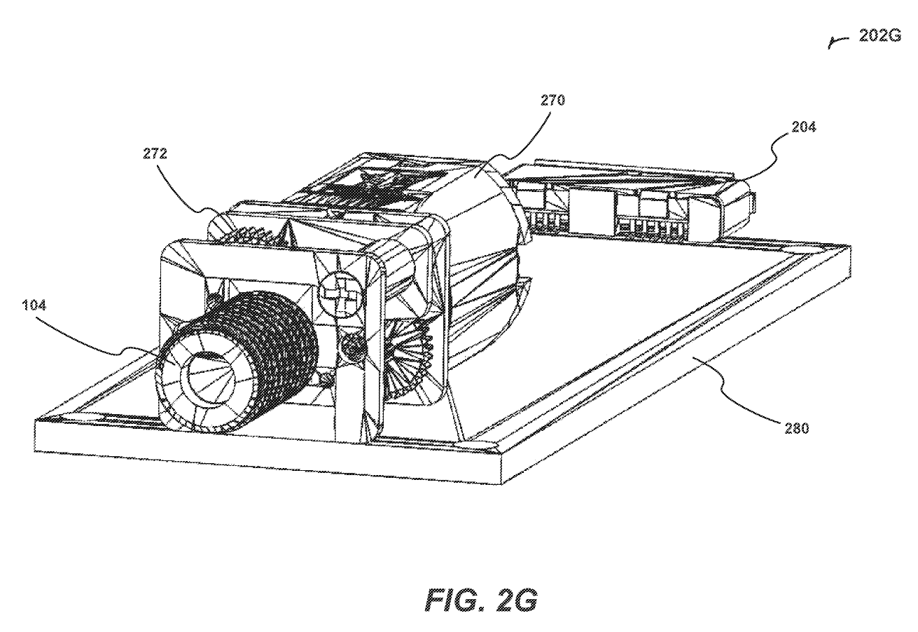

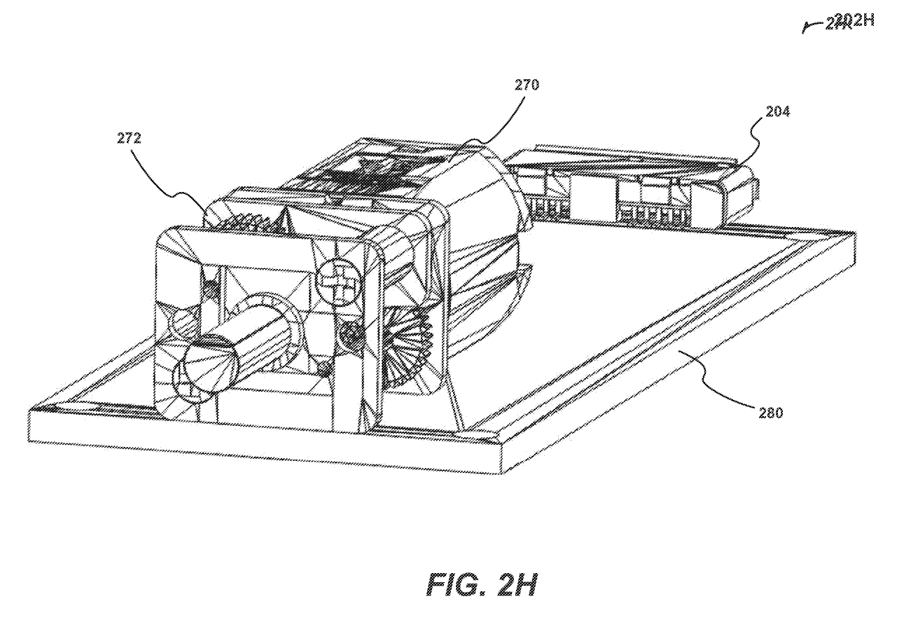

FIG. 2A illustrates the Smart Charging Adapter 202 being used with a standard charging adapter 220 for charging a mobile device 210, according to an embodiment. in certain examples, the Smart Charging Adapter 202 is used to charge a lithium ion battery of the mobile device 210. The Smart Charging Adapter 202. has a female port 204 that accepts a male connector 206 of a standard charging adapter 220. The Smart Charging Adapter 202 also has a male connector 206 that plugs into the female port 204 of the mobile device 210. The female port 204 and the male connector 206 of the Smart Charging Adapter 202 may conform to a standard, such as Micro USB, Lightning, or the like.

Inside of Smart Charging Adapter 202 is the cylinder 102 and the screw 104 illustrated in FIG. 1 and described in the accompanying paragraphs. The tip 212 of the cylinder 102 is made of rubber (or some other appropriate material) and connects the cylinder 102 to the male end of the Smart Charging Adapter 202. The tip 212 of the cylinder 102 prevents the Smart Charging Adapter 202 from causing damage to the mobile device 210. The tip 212 of the cylinder 102 may be prevented from rotating, such as by using a swivel.

The Smart Charging Adapter 202 may physically disconnect from the charging port of the mobile device 210 by extending itself from around the connector at a low speed while exerting pressure on the mobile device 210 near the charging port 204. After extending a sufficient distance to disconnect the connector from the charging port 204, the cylindrical component retracts back into the adapter. The cylindrical component retracts by reversing its direction of rotation.

In an embodiment, the cylinder 102 has rails 110 to prevent rotational motion of the cylinder 102 yet allow the cylinder 102 to move along the axis of the rails. The cylinder 102 is also threaded to fit the screw 104. Upon the Smart Charging Adapter 202 detecting or becoming informed that the battery of the mobile device 210 is fully charged, the screw 104 begins rotating counterclockwise, causing the cylinder 102 to move along the rails 110 away from the connector.

FIG. 2B is a perspective view 202B of the Smart Charging Adapter 202, according to an embodiment. The Smart Charging Adapter 202 has a male connector 206 protruding from one end and a female port 204 on the end opposite the male connector 206. In an embodiment, the housing 250 of the Smart Charging Adapter 202 may have a height 260 of 12.7 cm (0.5 in.), a length 262 of 50.8 cm (2.0 in.), and a width 264 of 25.4 cm (1.0 in.).

The housing 250 of the Smart Charging Adapter 202 may include a light 252, such as a light emitting diode (“LED”), at the top of the housing 250. The light 252 may be lit when the Smart Charging Adapter 202 is in one or more of various states. The light 252 may emit different colors of light (e.g., yellow, orange, red, green, blue, etc.); one or more colors of light may correspond to one or more states of the Smart Charging Adapter 202. The light 252 may produce constant light or may blink at one or more frequencies.

The housing 250 of the Smart Charging Adapter 202 may include a. button 254. When pressed, the button 254 may cause the Smart Charging Adapter 202 to turn on, turn off, or some other function. The button 254 may itself have a light instead of or in addition to the light 252.

FIG. 2C is a partial cut-away perspective view 202C of the Smart Charging Adapter 202, according to an embodiment. Visible within the partial cut-away perspective view 202C of the Smart Charging Adapter 202 is the female port 204, the male connector 206, the screw 104, a gear motor 270, gears 272, moving component 274, and tip 212. Also visible is the portion of the housing 250 of the Smart Charging Adapter 202 that has not been cut-away. The gear motor 270 and the female port 204 are attached to a PCB board 280, which in turn is attached to the housing 250 of the Smart Charging Adapter 202. The PCB board 280 also includes electrical connections to connect the electrical leads of the male connector 206 with the electrical leads of the female port 204.

Instead of the cylinder 102 illustrated in FIGS. 1 and 2, the embodiments illustrated in FIGS. 2C-2H use a rectangular moving component 274. The moving component 274 has a threaded interior that allows the screw 104 to be threaded into and out of the moving component 274. The rectangular shape of the moving component 274 prevents the moving component 274 from rotating within the housing 250 of the Smart Charging Adapter 202.

FIG. 2D is a partial cut-away perspective view 202D of the Smart Charging Adapter 202, according to an embodiment. Visible within the partial cut-away perspective view 202D of the Smart Charging Adapter 202 is the female port 204, the male connector 206, the gear motor 270, gears 272, moving component 274, screw 104, and tip 212. The moving component 274 has a threaded interior 106, allowing the screw 104 to be threaded into and out of the moving component 274. Also visible is the portion of the housing 250 of the Smart Charging Adapter 202 that has not been cut-away. The gear motor 270 and the female port 204 are attached to a PCB board 280, which in turn is attached via posts 282 to the housing 250 of the Smart Charging Adapter 202.

FIG. 2E is a partial cut-away perspective view 202E of the Smart Charging Adapter 202, according to an embodiment. Visible within the partial cut-away perspective view 202E of the Smart Charging Adapter 202 is the female port 204, the male connector 206, the gear motor 270, gears 272, moving component 274. screw 104, and tip 212. The moving component 274 has a threaded interior 106, allowing the screw 104 to be threaded into and out of the moving component 274. The gear motor 270 and the female port 204 are attached to a PCB board 280.

FIG. 2F is a partial cut-away perspective view 202F of the Smart Charging Adapter 202, according to an embodiment. Visible within the partial cut-away perspective view 202F of the Smart Charging Adapter 202 is the female port 204, the gear motor 270, gears 272, moving component 274, and screw 104. The male connector 206 and the tip 212 have been removed, thus allowing the threaded interior 106 of the moving component 274 to be seen. The threaded interior 106 allows the screw 104 to be threaded into and out of the moving component 274. The gear motor 270 and the female port 204 are attached to a PCB board 280.

FIG. 2G is a partial cut-away perspective view 202G of the Smart Charging Adapter 202, according to an embodiment. Visible within the partial cut-away perspective view 202G of the Smart Charging Adapter 202 is the female port 204, the gear motor 270, gears 272, and screw 104. The male connector 206, the tip 212, and the moving component 274 have been removed, thus allowing an unobstructed view of the screw 104. The gear motor 270 and the female port 204 are attached to a PCB board 280.

FIG. 2H is a partial cut-away perspective view 202H of the Smart Charging Adapter 202, according to an embodiment. Visible within the partial cut-away perspective view 202H of the Smart Charging Adapter 202 is the female port 204, the gear motor 270 and gears 272. The male connector 206, the tip 212, the moving component 274, and the screw 104 have been removed, thus allowing an unobstructed view of the gear motor 270 and gears 272. The gear motor 270 and the female port 204 are attached to a PCB board 280.

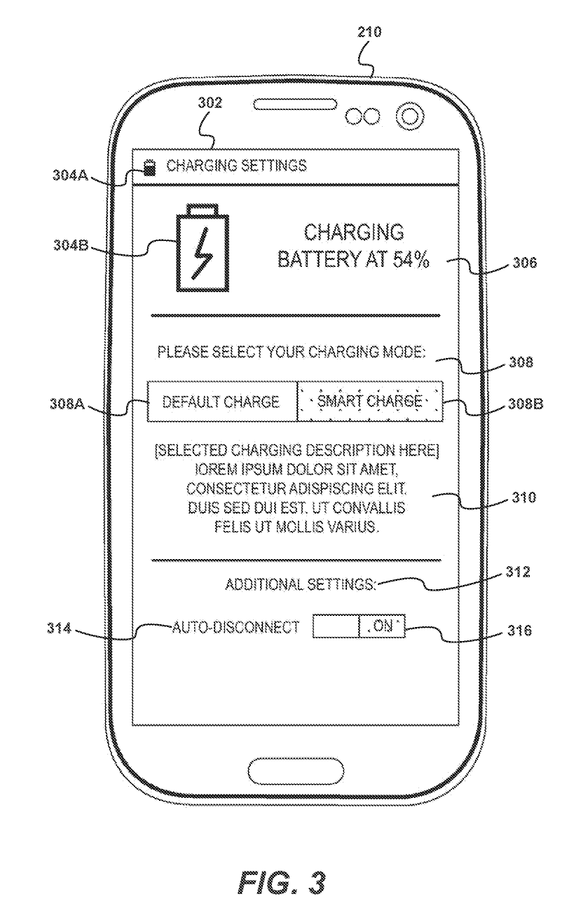

FIG. 3 illustrates a charge settings screen 302 of a Smart Charging app UI executing on the mobile device 210, according to an embodiment. The charge settings screen 302 may display one or more charging icons 304A, 304B while the battery of the mobile device 210 is charging. The charge settings screen 302 may also display the current charge state 306 (e.g., the current charge percentage) of the battery.

The charge settings screen 302 may allow a user of the mobile device 210 to select a charging mode 308. For example, the charge settings screen 302 may allow a user of the mobile device 210 to select either a Default Charge mode 308A or a Smart Charge mode 308B. A charging mode description 310 of the selected charging mode 308 may be displayed beneath the selection element 308A, 308B for that charging mode 308.

The charge settings screen 302 may allow the user of the mobile device 210 to modify additional settings 312. For example, the charge settings screen 302 may include an auto-disconnect control element 314 to allow a user to enable or disable an auto-disconnect feature of the Smart Charging Adapter 202. When auto-disconnect is enabled, the Smart Charging Adapter 202 automatically disconnects from the mobile device 210 when signaled by the Smart Charging app.

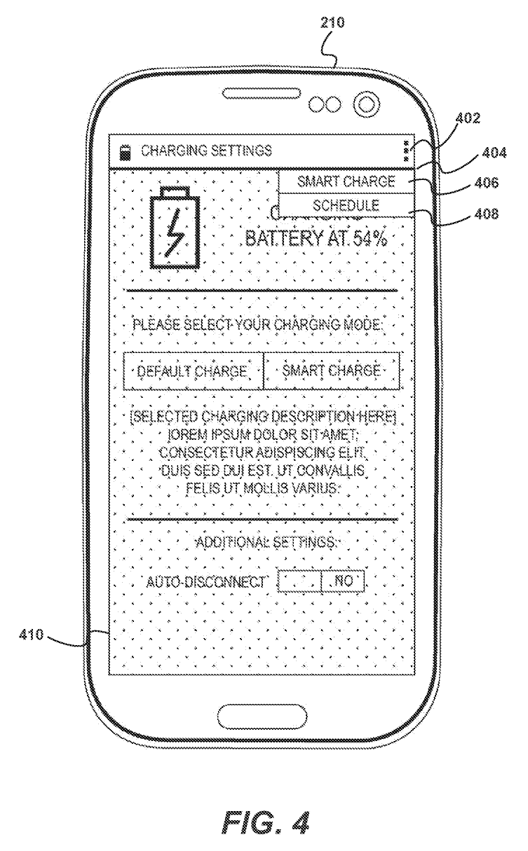

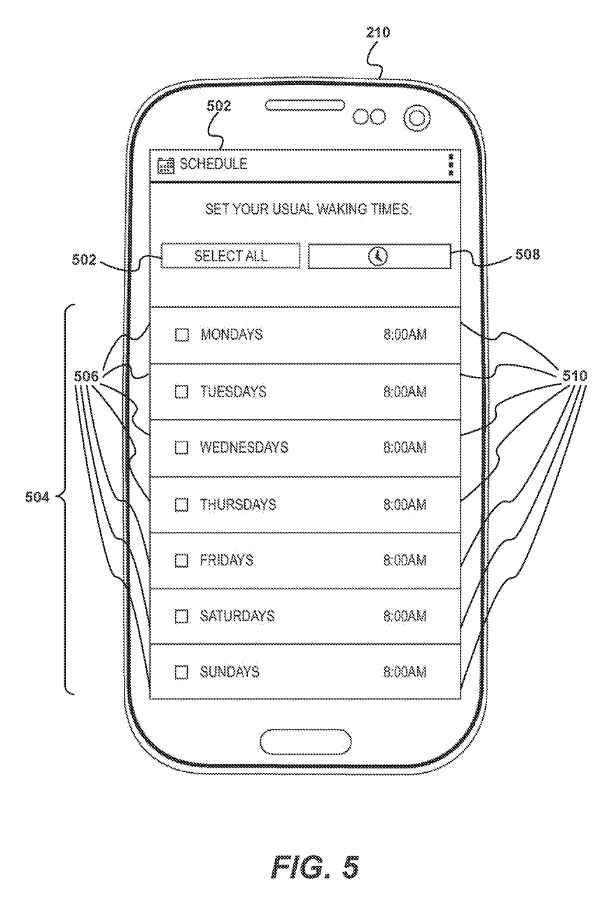

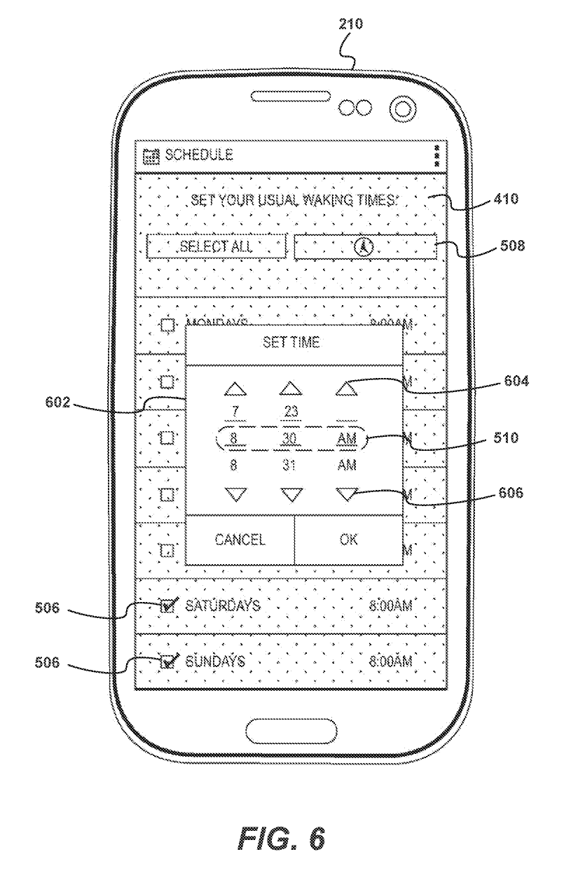

FIG. 4 illustrates a screen selection user interface element 402 of the Smart Charging app UI that allows the user to switch between screens of the Smart Charging app UI, according to an embodiment. Upon being selected, the screen selection user interface element 402 may display a screen selection dialog 404. The screen selection dialog 404 may have two or more selectable elements, with each selectable element corresponding to a respective screen or view of the Smart Charging app UI. For example, the screen selection dialog 404 illustrated in FIG. 4 allows the user to select one of: “Charge Settings,” 406, which corresponds to the Charge Settings screen described in FIG. 3, and “Schedule,” which corresponds to the schedule screen described in FIGS. 5 and 6.

In an embodiment, the screen selection dialog 404 may be displayed as a “light-box” in that the portion 410 of the screen that is not part of the screen selection dialog 404 may be dimmed or darkened as compared to the screen selection dialog 404. Furthermore, the screen selection dialog 404 may be “modal,” meaning that, while the screen selection dialog 404 is open, the Smart Charging app UI will only accept user input for the screen selection dialog 404.

Upon selecting a selectable element, the Smart Charging app UI may display the screen or view of the Smart Charging app UI corresponding to the selected element and may cease to display the screen selection dialog 404. Selecting the screen selection user interface element 402 while the screen selection dialog 404 is open may cause the screen selection dialog 404 to close.

FIG. 5 illustrates a schedule screen 502 of the Smart Charging app UI executing on the mobile device 210, according to an embodiment. The schedule screen 502 may include a list of days 504. A day may be selected by selecting the checkbox 506 corresponding to the day. Zero or more days may be selected. The days may be selected individually or in groups. Once one or more days are selected, the user may choose to edit the wake-up time(s) 510 for the selected day(s) by selecting the clock button 508. Selecting the clock button 508 may prompt the user to edit the waking time(s) 510 for the selected day(s), as illustrated in FIG. 6. The user may also select multiple days to set the wake-up times 510 for the selected days simultaneously. The wake-up times 510 are used by the Smart Charging app to determine how and when to charge the battery of the mobile device 210, as explained below.

FIG. 6 illustrates setting waking times 510 using the schedule screen 502 of the Smart Charging app UI, according to an embodiment. In the example illustrated in FIG. 6, the user has selected “Saturdays” and “Sundays,” as indicated by the checkmarks 506 in the boxes for Saturday and Sunday. Upon the clock button 508 being selected, the Smart Charging app UI may display a time picker dialog 602; the time picker dialog 602 may be used to select a time for the selected day(s).

Although the schedule screen 502 embodiments illustrated in FIGS. 5 and 6 allow a user to set one wake-up time 510 for each day of the week, other embodiments may have more sophisticated options. For example, the schedule screen 502 may present a user with a calendar control, allowing the user to set wake-up times 510 for each day of the next calendar month.

Interactions Between the Smart Charging App and the Smart Charging Adapter 202

In describing batteries, discharge current is often expressed as a “C-rate” in order to normalize against battery capacity, which is often very different between batteries. A C-rate is a measure of the rate at which a battery is discharged relative to the battery's maximum capacity. A 1C rate means that the discharge current will discharge the entire battery in 1 hour. For a battery with a capacity of 100 Amp-hrs, this equates to a discharge current of 100 Amps. A 5C rate for this battery would be 500 Amps, and a C/2 rate would be 50 Amps.

Almost all new mobile devices are packaged with a battery charger. Recently, most new mobile devices are packaged with a “rapid charger,” which usually charges the battery of the mobile device at 0.8C-1.2C, only slowing down as the battery approaches full capacity. Rapid chargers are designed to charge the battery as fast as possible, which is not required for overnight charging. Additionally, charging some types of battery (e.g., a lithium ion battery) with too large a charge current can reduce the lifetime of the battery. Further, keeping the battery charge level at 100% for a long period of time (as with conventional overnight charging) can also reduce the lifetime of the battery.

Smart Charge Mode: When the Smart Charging app is in Smart Charge mode, the charging of the battery of the mobile device 210 is divided into two phases. In the first phase, the Smart Charging app allows the battery of the mobile device 210 to charge at the lowest available current (e.g., 0.5C) until the battery reaches 80% capacity. Upon reaching 80%, the Smart Charging app pauses charging until the calculated time for the second charging phase to start. In the second phase, the Smart Charging app allows the battery of the mobile device 210 to charge at a maximum rate of 0.5C until the battery reaches 100% capacity. The Smart Charging app calculates how long the two phases of charging will take: 1) Current state of charge (SoC) to 80% SoC and 2) 80% SoC to 100% SoC. The Smart Charging app thus determines the time at which to resume charging by calculating the next wake-up time minus the time required for the second charging phase.

In an example scenario, a user is about to go to sleep and wants their mobile phone to have a fully charged battery when the user wakes up. Prior to going to sleep, the user connects the mobile phone's charger to the Smart Charging Adapter and connects the Smart Charging Adapter to the user's mobile phone. The Smart Charging app launches and detects that the battery is at 30% capacity. The Smart Charging Adapter detects that the mobile phone's charger uses 0.8C, and informs the Smart Charging app of this. In response, the Smart Charging app decreases the charging rate to 0.5C—the optimum rate to reduce battery stress and heat. The Smart Charging app then calculates how long it will take to charge at 0.5C for the two phases of charging. The first phase is from the battery's current state (30% capacity) to 80% capacity. The second phase is from 80% capacity to 100% capacity. Both of these phases use the 0.5C charging rate. The Smart Charging app then calculates, based on the next scheduled “wake-up time,” how long the user will sleep. If the user goes to sleep at 10:00 P.M. and the next wake-up time is set to 6:00 A.M., the Smart Charging app has 8 hours to perform both phases of charging. In this example, the battery is kept at less than 100% charge for most of the night, which may extend the lifetime of the battery by reducing the amount of time that the battery is needlessly kept at 100% charge.

In the first phase of charging, the Smart Charging Adapter charges the battery at the 0.5C charging rate and pauses upon reaching 80% capacity. This is the first phase of charging will take about 1 hour. The Smart Charging app determines that the second phase of charging, from 80% capacity to 100% capacity, will take about 24 minutes based on the 0.5C charging rate. The Smart Charging app will pause the battery charging from 11:00 P.M. to 5:36 A.M.; during this period, the Smart Charging app monitors the battery level, and watches for drain caused by background activity. Also during this period, the Smart Charging app recalculates the second phase of charging every 30 minutes to determine if the battery drops below 80% capacity, thus impacting the time necessary for the second phase of charging. Assuming there is a 5% capacity drain by the end of the 6 hours in which charging is paused, the Smart Charging app recalculates the time required for the second phase of charging from 24 minutes to 32 minutes. Based on this updated estimate, the Smart Charging app resumes the 0.5C charging rate at 5:28 A.M. and charges the battery until 6:00 A.M., at which time the battery will be at 100% capacity.

App Launch Workflow

When the Smart Charging Adapter 202 is plugged into a mobile device, it triggers the Smart Charging app on the mobile device 210 to launch. The Smart Charging app recognizes that a Smart Charging Adapter 202 has been plugged into the mobile device 210 and triggers a series of calculations to be made and messages to be sent to the Smart Charging Adapter 202.

The Smart Charging app queries for the current battery level and the battery capacity of the mobile device 210. The Smart Charging app then asks the Smart Charging Adapter 202 for the maximum charge rate that the mobile device 210 will accept. The Smart Charging app retrieves the current settings (e.g., Charge Mode, Waking Schedule, Auto-Disconnect (e.g., enabled or disabled), etc.) from the Smart Charging app's UI.

If the Charging Mode is Set to Default Mode

The Smart Charging app sends a message to the Smart Charging Adapter 202 to start default charging. The message includes the battery capacity of the mobile device 210 and whether the Smart Charging Adapter 202 should auto-disconnect when the mobile device 210 is fully charged. The Smart Charging Adapter 202 then monitors the current draw and, based on the battery capacity, determines when the mobile device 210 is fully charged. If auto-disconnect is enabled, the Smart Charging Adapter 202 automatically disconnects from the mobile device 210 when the battery of the mobile device 210 is fully charged. Default mode is also known as “regular” mode.

If the Charging Mode is Set to Smart Charging Mode

The Smart Charging app sets the level of current that will be used for the first charging phase to the lesser of [0.5*Battery Capacity] and [reported maximum charge rate accepted by the phone]. The Smart Charging app identifies how much time remains until the next “Wake-Up Time”. The Smart Charging app calculates how much time is required for the first and second charging phases.

1. If a sufficient amount of time remains to charge the battery of the mobile device 210 in Smart Charging Mode prior to the next upcoming “Wake-Up Time,” one of the following actions are performed:

A) If the mobile device 210 began charging with a battery level less than 80%, the Smart Charging app sets an alarm on the mobile device 210 scheduled for the time when the battery of mobile device 210 should reach 80% capacity.

B) If the mobile device 210 began charging with a battery level greater than 80%, the Smart Charging app sends the Smart Charging Adapter 202 a command to stop charging and sets an alarm on the mobile device 210 based on the calculations for when the mobile device 210 needs to start charging again in order to reach 100% capacity before the next “Wake-up Time.”

2. If an insufficient amount of time remains for charging to completion the mobile device 210 in Smart Charging Mode prior to the next “Wake Up Time,” the Smart Charging app displays a message reporting to the user that Smart Charging mode will not have enough time to complete and allows the user to either switch to a different charging mode or continue with Smart Charging Mode. If the user switches charging modes, the Smart Charging app updates its UI to be set to the selected charging mode (e.g., Default Mode) and sends a command to the charger to begin charging in the selected charging mode. If the user does not switch modes, the Smart Charging app continues charging in Smart Charging Mode as if a sufficient amount of time remains for charging to completion the mobile device 210 in Smart Charging Mode prior to the next “Wake Up Time.”

Alarm Workflow

When the alarm on the mobile device 210 “goes off,” the Smart Charging app checks the mobile device's 210 current battery level.

1. If the battery level is still less than 80% capacity, the Smart Charging app will allow the Smart Charging Adapter 202 to continue charging the battery. The Smart Charging app recalculates the time remaining for the first charging phase and the charging time for the second charging phase, then compares that time to the time remaining before the next “Wake Up Time.”

A) if a sufficient amount of time remains to charge the mobile device 210 prior to the next “Wake Up Time,” the Smart Charging app sets an alarm on the mobile device 210 scheduled for the time when the battery of the mobile device 210 should reach 80% capacity.

B) If an insufficient amount of time remains to charge the mobile device 210 in Smart Charging Mode prior to the next “Wake Up Time,” the Smart Charging app sends a command to the Smart Charging Adapter 202 to charge in Default Mode.

2. If the battery level is greater than 80% capacity, the Smart Charging app recalculates the time necessary to charge the battery to 100% capacity and compares that time to the time remaining before the next “Wake Up Time.”

A) If extra time remains than necessary to charge the battery^{,} to 100% capacity prior to the next “Wake Up Time,” the Smart Charging app sends a command to the Smart Charging Adapter 202 to stop charging and schedules a new alarm scheduled for the next Wake Up Time—the time necessary for the second charging phase.

B) If extra time does not remain, the Smart Charging app sends a command to the Smart Charging Adapter 202 to start charging in Default Mode.

The Smart Charging Adapter 202 detects when the battery has reached 100% capacity and, depending on whether Auto-Disconnect was enabled, disconnects from the mobile device 210. The Smart Charging Adapter 202 may use one or more methods (e.g., current drop) for detecting when the battery has reached 100% capacity.

Altering the Charge Current Based on Time Limit

If the maximum charging rate the battery accepts is higher than 0.5C and not enough time remains to charge at the rate of 0.5C, the charging current may be slowly incremented until the charging current reaches the Maximum Charging Rate. However, some mobile devices 210 and/or mobile device chargers may not allow the battery to receive a charging current of 0.5C or higher.

Alarm Workflow Pseudocode
Get batteryLevel
Get userSettings (wakeUpTime, currentDropValue)
Get timeRemaining until wakingTime
Get currentDropValue
If (batteryLevel<80%)
   If ((currentDropValue>batteryLevel) and (currentDropValue<80%)):
      //add constant to 80 estimation
      A=constant current time (batteryLevel->currentDropValue)
      B=variable current time (currentDropValue->80%)
      timeTo80Percent=A+B
      timeTo100Percent=variable current time (80%->100%)
   Else IF (currentDropValue>80%):
      //add constant to 100 estimation
      timeTo80Percent=constant current time (batteryLevel->80%)
      A=constant current time (80%->currentDropValue)
      B=variable current time (currentDropValue->100%)
      timeTo100Percent=A+B
   Else [currentDropValue already happened]
      //only do variable estimations
      timeTo80Percent=variable current time (batteryLevel->80%)
      timeTo100Percent=variable current time (80%->100%)
   If ((timeTo80Percent+timeTo100Percent)>timeRemaining)
      //there is not enough time to charge it all so start at full blast
      Send MSG [Default][Disconnect][Capacity]
   Else [is enough time for both modes]
      setAlarm (currentTime+timeTo80Percent)
      send MSG [Smart Charging][Disconnect][Capacity]
Else
   If (currentDropValue<batteryLevel)
      timeTo100Percent=variable current time (batteryLevel->100%)
   else [currentDropValue is still going to happen]
      A=constant current time (batteryLevel->currentDropValue)
      B=variable current time (currentDropValue->100%)
      timeTo100Percent=A+B
   if (timeRemaining<=timeTo100Percent)
      send MSG [Default][Disconnect][Capacity]
   else
      send MSG [Stop Charging]
      setAlarm (wakingTime timeTo100Percent)

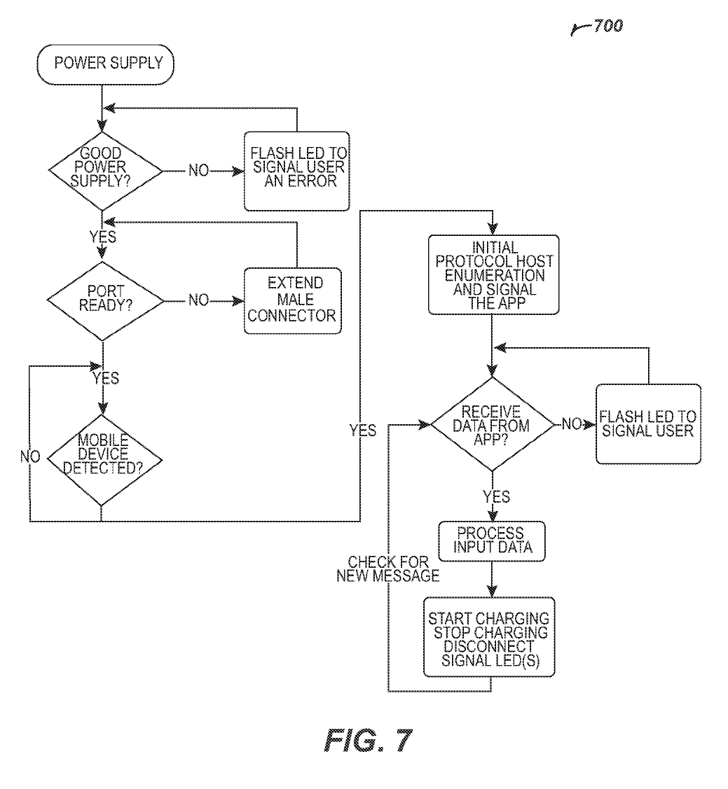

FIG. 7 is a flowchart of the Smart Charging Adapter 202 operating with the Smart Charging app executing on the mobile device 210, according to an embodiment. The Smart Charging Adapter 202 runs on an external direct current (DC) power supply of 5 volts that is capable of delivering a minimum constant electric current of 2.1 Amperes (Amps). The external DC power supply provides power for the Smart Charging Adapter 202 and to charge the battery of the mobile device 210. The Smart Charging Adapter 202 has a maximum input voltage tolerance of 10 volts DC.

The Smart Charging Adapter 202 may have two external interfaces. The first external interface is a USB 3.0 Micro-B connector (male) to connect with the mobile device 210 for charging and communication. The second interface is a USB 2.0 Micro-AB receptor (female) to receive power from the external DC power supply.

When good input power is detected, the Smart Charging Adapter 202 initiates its internal circuitry, supplies the charge port with the power needed to start the USB host enumeration, and extends the male connector 206 into a ready position (if the male connector 206 is not already in the ready position.) Upon detection of a mobile device 210, the Smart Charging Adapter 202 starts communicating with the Smart Charging app to get relevant information, such as the state of charge, rate to charge, when to start charging, when to pause charging, and when to disconnect from the mobile device 210, etc.

In an embodiment, the Smart Charging Adapter 202 has a light 252 that indicates a current state of the Smart Charging Adapter 202. For example, the light 252 may be constantly lit while the mobile device is charging 210, blinking when the charging is paused by the Smart Charging App, and off when the battery of the mobile device 210 has been fully charged and the Smart Charging Adapter 202 has retracted.

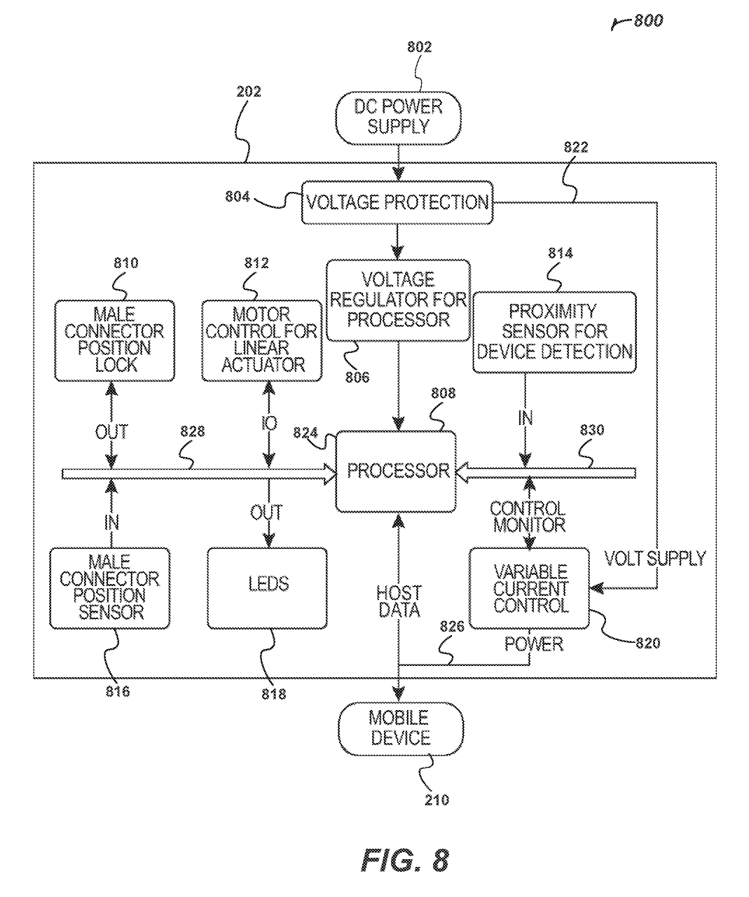

FIG. 8 is a block diagram of the internal circuitry of the Smart Charging Adapter 202, according to an embodiment.

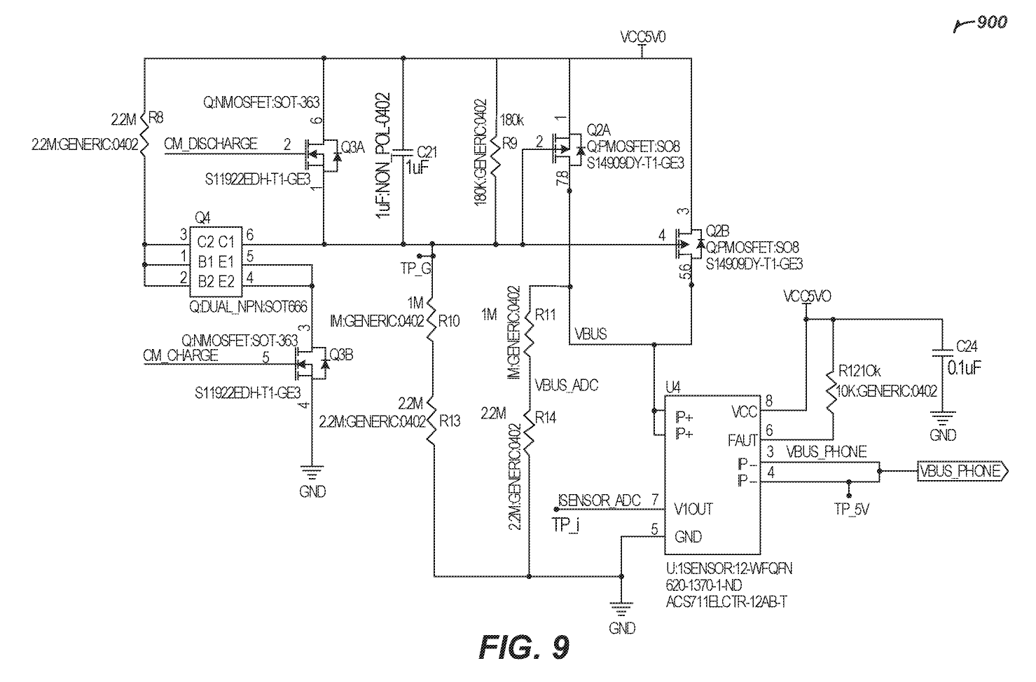

FIG. 9 is an electrical diagram of an output current controller of the Smart Charging Adapter 202, according to an embodiment. The two MOSFET Q3A and Q5A connected in parallel can output up to 16 A of current to the power line to charge any mobile device 210 with the supported interface. Q4 is a current mirror used to charge C21 to control the MOSFET gate voltage. By changing the gate voltage using CM_CHARGE and CM_DISCHARGE, the gate voltage can adjust to any level to achieve the desired current flow output. U4 is a current monitoring circuit that provides feedback to the microcontroller to adjust automatically the gate voltage to achieve the set current value.

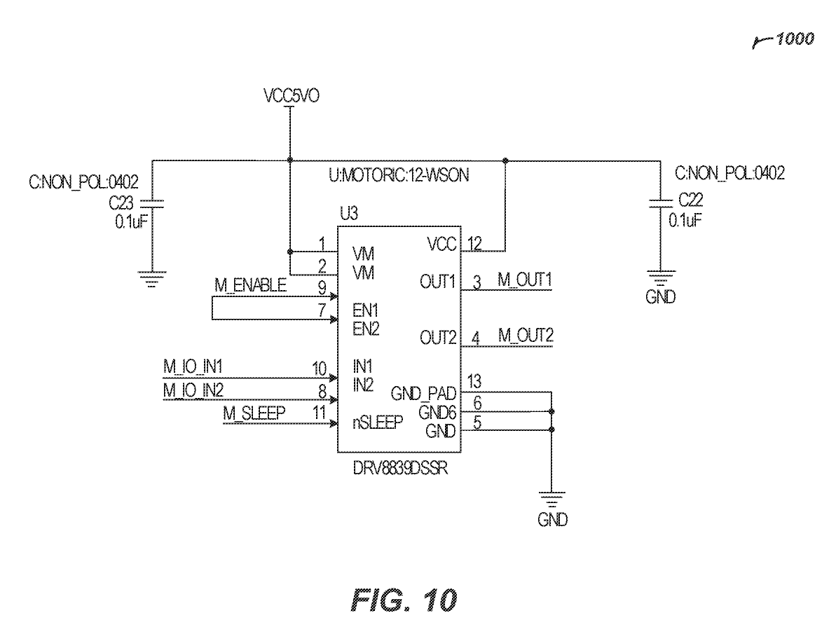

FIG. 10 is an electrical diagram of a motor controller of the Smart Charging Adapter 202, according to an embodiment. The motor controller may be a standard half bridge motor driver IC with 1.8 A max output. The motor controller is used to control the motor to retract and extend the male connector 206.

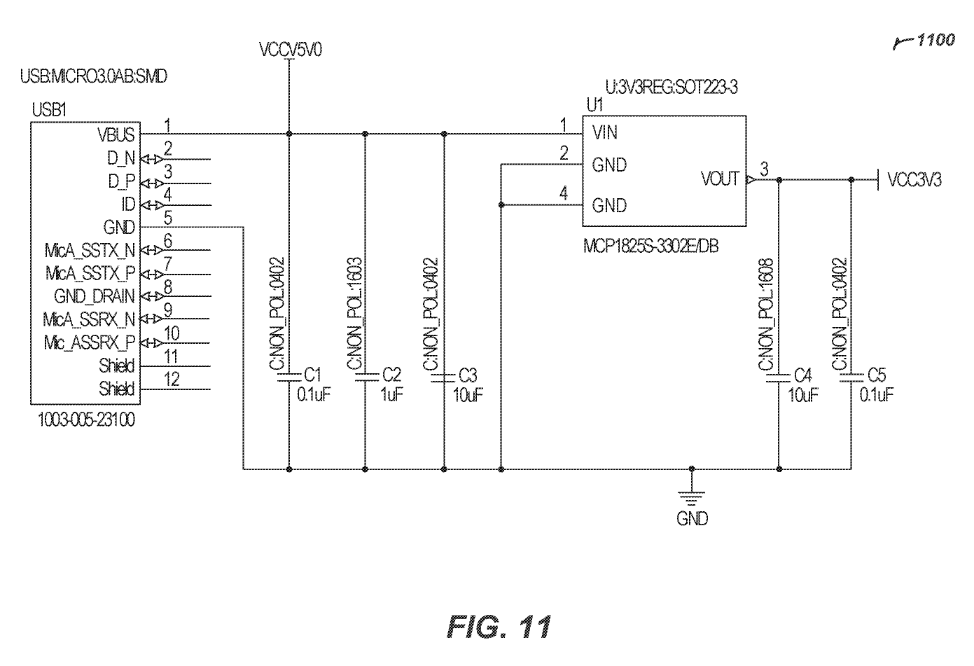

FIG. 11 is an electrical diagram of a power regulator of the Smart Charging Adapter 202, according to an embodiment. USB1 is the input power (5V) for the Smart Charging Adapter 202 and UI is a standard 3.3V regulator to regulate the power for the microprocessor (which is not 5V tolerant).

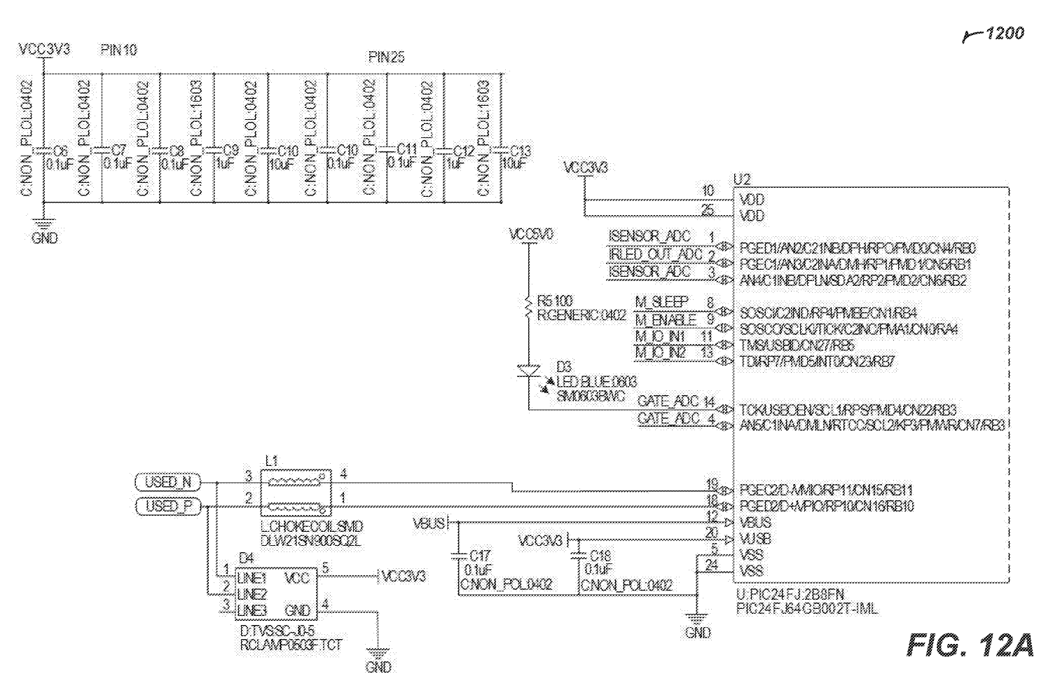

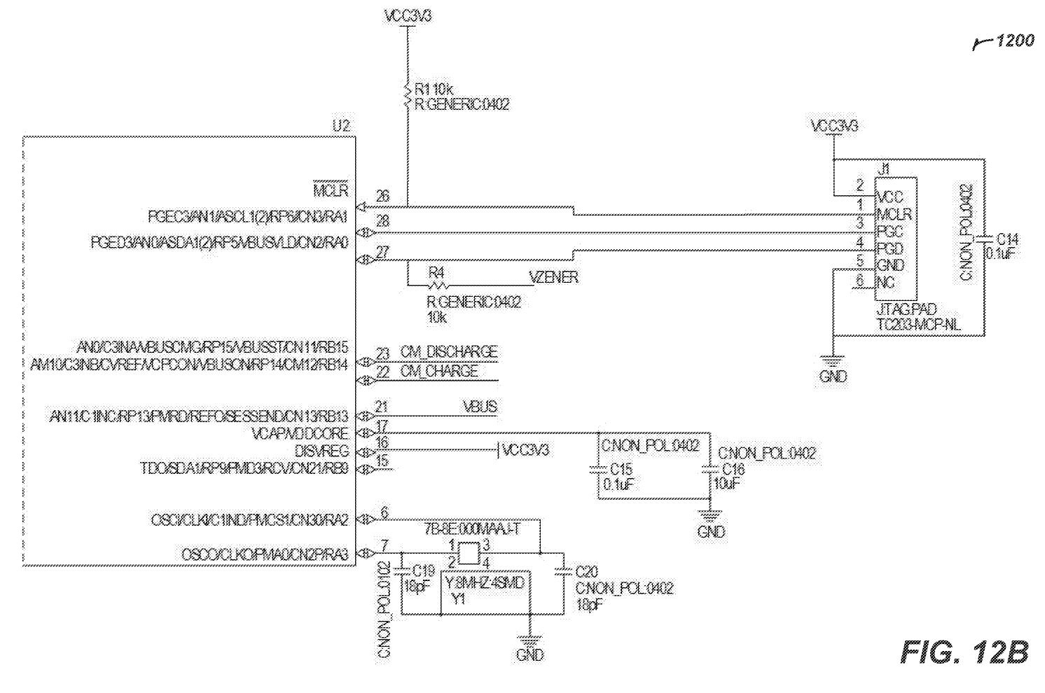

FIGS. 12A and 12B are an electrical diagram of a processor of the Smart Charging Adapter 202, according to an embodiment. The processor is the brain of the Smart Charging Adapter 202. The Smart Charging Adapter's 202 firmware algorithms may reside in the processor. The rectangle (U2) is the microcontroller that monitors the current flow to the mobile device 210, controls when to retract or extend the male connector 206, and initiates communication with the Smart Charging app via USB. One-half of the microcontroller U2 is included in each of FIGS. 12A and 12B. The dashed line indicates where the two halves are joined.

The bottom left is the USB interface, the bottom right is the clock oscillator, the right corner is the programming header for the processor, and the top is the power decoupling caps to ensure a stable power supply for the processor.

### ADDITIONAL DISCLOSURE AND EXAMPLES

Example 1 includes subject matter (such as a method of controlling charging of a battery of an electronic device, a means for performing acts, or a machine-readable medium including instructions that, when performed by the machine, cause the machine to perform acts) comprising selectively charging the battery according to a first charging mode or a second charging mode, wherein the first charging mode includes charging the battery using a first mode charge current, wherein the second charging mode includes charging the battery using at least a first charge phase and a second charge phase, wherein the battery is charged using charge current less than the first mode charge current during at least one of the first and second charge phases of the second charging mode, and wherein a start time of the first charge phase and an end time of the second charge phase are determined by the electronic device according to a specified idle time of the electrical device, the end time of the first charge phase is determined according to a first specified battery charge level, and the start time of the second charge phase is determined according to a difference between the first specified battery charge level and a second specified battery charge level.

In Example 2, the subject matter of Example 1 optionally includes enabling the second charging mode upon receiving an indication of presence of a charging device, separate from the electronic device, at a port of the electronic device.

in Example 3, the subject matter of Example 2 optionally includes providing an indication to the charging device to auto-disconnect from the electronic device upon completion of the second charge phase of the second charging mode.

In Example 4, the subject matter of one or any combination of Examples 1-3 optionally includes enabling the first charging mode or the second charging mode according to an input received from a user interface of the electronic device.

In Example 5, the subject matter of one or any combination of Examples 1-4 optionally includes receiving a user schedule into the electronic device via a user interface; and determining the specified idle time by the electronic device according to the user schedule.

In Example 6, the subject matter of Example 5 optionally includes receiving indications of idle times for a number of days, and wherein the method includes scheduling the first and second charge phases of the second charging mode during the indicated idle times.

In Example 7, the subject matter of one or any combination of Examples 1-6 optionally includes receiving the specified idle time into the electronic device via a user interface, and calculating the start time and end time of the first and second charge phases of the second charging mode according to the idle time.

In Example 8, the subject matter of one or any combination of Examples 1-7 optionally includes charging the battery during at least one of the first charge phase and the second charge phase of the second charging mode using a charge current with a lower C-rate value than the first mode charge current.

In Example 9, the subject matter of one or any combination of Examples 1-8 optionally includes determining the charge level of the battery a specified time after the end time of the first charge phase and recalculating the start time of the second charge phase using the determined charge level.

In Example 10, the subject matter of one or any combination of Examples 1-9 optionally includes changing the charging mode from the second charging mode to the first charging mode upon determining that the first specified battery charge level is not reached by the start time of the second charge phase when in the second charging mode.

In Example 11, the subject matter of one or any combination of Examples 1-10 optionally includes downloading, by the electronic device, a software application to calculate the start times and end times of the first and second charge phases of the second charging mode upon receiving download information from a charging device operatively connected to a port of the electronic device.

in Example 12, the subject matter of one or any combination of Examples 1-11 optionally includes charging a lithium ion battery of a mobile phone according to the first charging mode or the second charging mode.

Example 13 can include subject matter (such as a charging adapter for an electronic device), or can optionally be combined with one or any^{,} combination of Examples 1-12 to include such subject matter, comprising a mechanical connector configured for mechanical coupling to a charge source; a device port configured to provide electrical battery charging energy to the electronic device and communicate electrical signals with the electronic device; and control circuitry configured to auto-disconnect the mechanical connector from the electronic device upon receiving a disconnect signal from the electronic device via the device port.

In Example 14, the subject matter of Example 13 optionally includes control circuitry configured to communicate a charge start signal via the device port upon connection of the mechanical port to the charge source.

In Example 15, the subject matter of one or both of Examples 13 and 14 optionally includes a moving component with a threaded interior; a screw including a threaded exterior, the screw threaded to the threaded interior of the moving component; and an adapter housing, wherein the moving component and the screw are arranged within the adapter housing; wherein the control circuitry is configured to initiate rotation of the screw to move the moving component relative to the adapter housing in response to receiving the disconnect signal.

In Example 16, the subject matter of Example 15 optionally includes a device port arranged at a wall of the adapter housing, wherein the moving component includes a cylinder arranged around the device port, and wherein rotation of the screw in response to receiving the disconnect signal causes the cylinder of the moving component to extend beyond the wall of the adapter housing.

In Example 17, the subject matter of one or both of Examples 15 and 16 optionally includes a moving component that includes the device port, and wherein rotation of the screw in response to receiving the disconnect signal causes the moving component and device port to retract within the adapter housing.

In Example 18, the subject matter of one or any combination of Examples 13-17 optionally includes a memory to store software download information; and wherein the control circuitry is configured to communicate the software download information to the electronic device via the device port upon detecting presence of the electronic device.

In Example 19, the subject matter of one or any combination of Examples 13-18 optionally includes charging circuitry configured to provide the electrical battery charging energy to the electronic device using multiple levels of charge current.

Example 20 can include subject matter (such as a machine-readable medium including instructions that, when executed by processing circuitry of an electronic device, cause the electronic device to perform specified operations), or can optionally be combined with one or any combination of Examples 1-12 to include such subject matter, comprising selectively charging a battery of the electronic device according to a first charging mode or a second charging mode, wherein the first charging mode includes charging the battery uniformly using a first mode charge current, wherein the second charging mode includes charging the battery using at least a first charge phase and a second charge phase, wherein the battery is charged using charge current less than the first mode charge current during at least one of the first and second charge phases of the second charging mode, and wherein a start time of the first charge phase and an end time of the second charge phase are determined by the electronic device according to a specified idle time of the electrical device, the end time of the first charge phase is determined according to a first specified battery charge level, and the start time of the second charge phase is determined according to a difference between the first specified battery charge level and a second specified battery charge level.

In Example 21, the subject matter of Example 20 optionally includes instructions that cause the electronic device to: calculate the start times and end times of the first and second charge phases upon receiving an indication of presence of a charging device at a port of the electronic device; and communicate an indication to the charging device to auto-disconnect from the electronic device upon completion of the second charging phase.

In Example 22, the subject matter of one or both of Examples 20 and 21 optionally includes instructions that cause the electronic device to: enable the first charging mode or the second charging mode according to an input received from a user interface of the electronic device.

These non-limiting examples can be combined in any permutation or combination.

Conventional terms in the fields of electronics and computer systems have been used herein. The terms are known in the art and are provided only as a non-limiting example for convenience purposes.

Although specific embodiments have been illustrated and described herein, it will be appreciated by those of ordinary skill in the art that any arrangement that is calculated to achieve the same purpose may be substituted for the specific embodiments shown. Many adaptations will be apparent to those of ordinary skill in the art. Accordingly, this patent application is intended to cover any adaptations or variations.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, the present inventors also contemplate examples in which only those elements shown or described are provided. Moreover, the inventor also contemplates examples using any combination or permutation of those elements shown or described (or one or more aspects thereof), either with respect to a particular example (or one or more aspects thereof), or with respect to other examples (or one or more aspects thereof) shown or described herein.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. Moreover, the terms “first,” “second,” and “third,” etc. are used merely as labels, and are not intended to impose numerical requirements on their objects.

Method examples described herein may be machine or computer-implemented at least in part. Some examples may include a machine-readable medium or machine-readable medium encoded with instructions operable to configure an electronic device to perform methods as described in the above examples. An implementation of such methods may include code, such as microcode, assembly language code, a higher-level language code, or the like. Such code may include machine-readable instructions for performing various methods. The code may form portions of computer program products. Further, in an example, the code may be tangibly stored on one or more volatile, non-transitory, or non-volatile tangible machine-readable media, such as during execution or at other times. Examples of these tangible machine-readable media may include, but are not limited to, hard disks, removable magnetic disks, removable optical disks (e.g., compact disks and digital video disks), magnetic cassettes, memory cards or sticks, random access memories (RAMS), read-only memories (ROMs), and the like.

The above description is intended to be illustrative, and not restrictive. For example, the above-described examples (or one or more aspects thereof) may be used in combination with each other. Other embodiments may be used, such as by one of ordinary skill in the art upon reviewing the above description.

What is claimed is:

1. A method of controlling charging of a battery of an electronic device, the method comprising:
selectively charging the battery according to a first charging mode or a second charging mode, wherein the first charging mode includes charging the battery using a first mode charge current,
wherein the second charging mode includes charging the battery using at least a first charge phase and a second charge phase, wherein the battery is charged using charge current less than the first mode charge current during at least one of the first and second charge phases of the second charging mode, and
wherein a start time of the first charge phase and an end time of the second charge phase are determined by the electronic device according to a specified idle time of the electrical device, the end time of the first charge phase is determined according to a first specified battery charge level, and the start time of the second charge phase is determined according to a difference between the first specified battery charge level and a second specified battery charge level.

2. The method of claim 1, including enabling the second charging mode upon receiving an indication of presence of a charging device, separate from the electronic device, at a port of the electronic device.

3. The method of claim 2, wherein the method further includes providing an indication to the charging device to auto-disconnect from the electronic device upon completion of the second charge phase of the second charging mode.

4. The method of claim 1, including enabling the first charging mode or the second charging mode according to an input received from a user interface of the electronic device.

5. The method of claim 1, including receiving a user schedule into the electronic device via a user interface; and determining the specified idle time by the electronic device according to the user schedule.

6. The method of claim 5, wherein the receiving the user schedule includes receiving indications of idle times for a number of days, and wherein the method includes scheduling the first and second charge phases of the second charging mode during the indicated idle times.

7. The method of claim 1, including receiving the specified idle time into the electronic device via a user interface, and calculating the start time and end time of the first and second charge phases of the second charging mode according to the idle time.

8. The method of claim 1, wherein charging the battery according to the second charging mode includes charging the battery during at least one of the first charge phase and the second charge phase of the second charging mode using a charge current with a lower Crate value than the first mode charge current.

9. The method of claim 1, wherein charging the battery according to the second charging mode includes determining the charge level of the battery a specified time after the end time of the first charge phase and recalculating the start time of the second charge phase using the determined charge level.

10. The method of claim 1, including changing the charging mode from the second charging mode to the first charging mode upon determining that the first specified battery charge level is not reached by the start time of the second charge phase when in the second charging mode.

11. The method of claim 1, including downloading, by the electronic device, a software application to calculate the start times and end times of the first and second charge phases of the second charging mode upon receiving download information from a charging device operatively connected to a port of the electronic device.

12. The method of claim 1, wherein the charging the battery according to a first charging mode or a second charging mode includes charging a lithium ion battery of a mobile phone according to the first charging mode or the second charging mode.

13. A charging adapter for an electronic device, the charging adapter comprising:
a mechanical connector configured for mechanical coupling to a charge source;
a device port configured to provide electrical battery charging energy to the electronic device and communicate electrical signals with the electronic device; and
control circuitry configured to auto-disconnect the mechanical connector from the electronic device upon receiving a disconnect signal from the electronic device via the device port.

14. The charging adapter of claim 13, wherein the control circuitry is configured to communicate a charge start signal via the device port upon connection of the mechanical port to the charge source.

15. The charging adapter of claim 13, including:
a moving component with a threaded interior;
a screw including a threaded exterior, the screw threaded to the threaded interior of the moving component; and
an adapter housing, wherein the moving component and the screw are arranged within the adapter housing;
wherein the control circuitry is configured to initiate rotation of the screw to move the moving component relative to the adapter housing in response to receiving the disconnect signal.

16. The charging adapter of claim 15, wherein the device port is arranged at a wall of the adapter housing, wherein the moving component includes a cylinder arranged around the device port, and wherein rotation of the screw in response to receiving the disconnect signal causes the cylinder of the moving component to extend beyond the wall of the adapter housing.

17. The charging adapter of claim 15, wherein the moving component includes the device port, and wherein rotation of the screw in response to receiving the disconnect signal causes the moving component and device port to retract within the adapter housing.

18. The charging adapter of claim 13, including a memory to store software download information; and wherein the control circuitry is configured to communicate the software download information to the electronic device via the device port upon detecting presence of the electronic device.

19. The charging adapter of claim 13, including charging circuitry configured to provide the electrical battery charging energy to the electronic device using multiple levels of charge current.

20. A non-transitory machine-readable medium including instructions that, when executed by processing circuitry of an electronic device, cause the electronic device to perform operations comprising:
selectively charging a battery of the electronic device according to a first charging mode or a second charging mode, wherein the first charging mode includes charging the battery uniformly using a first mode charge current,
wherein the second charging mode includes charging the battery using at least a first charge phase and a second charge phase, wherein the battery is charged using charge current less than the first mode charge current during at least one of the first and second charge phases of the second charging mode, and
wherein a start time of the first charge phase and an end time of the second charge phase are determined by the electronic device according to a specified idle time of the electrical device, the end time of the first charge phase is determined according to a first specified battery charge level, and the start time of the second charge phase is determined according to a difference between the first specified battery charge level and a second specified battery charge level.

21. The non-transitory machine-readable medium of claim 20, including instructions that cause the electronic device to: calculate the start times and end times of the first and second charge phases upon receiving an indication of presence of a charging device at a port of the electronic device; and communicate an indication to the charging device to auto-disconnect from the electronic device upon completion of the second charging phase.

22. The non-transitory machine-readable medium of claim 20, including instructions that cause the electronic device to: enable the first charging mode or the second charging mode according to an input received from a user interface of the electronic device.
